(19) United States
(12) Patent Application Publication
(10) Pub. No.: US 2022/0297687 A1
(43) Pub. Date: Sep. 22, 2022

(54) DRIVING SUPPORT DEVICE

(71) Applicant: HONDA MOTOR CO., LTD., Tokyo (JP)

(72) Inventor: Taku YAMAZAKI, Tokyo (JP)

(73) Assignee: HONDA MOTOR CO., LTD., Tokyo (JP)

(21) Appl. No.: 17/679,816

(22) Filed: Feb. 24, 2022

(30) Foreign Application Priority Data
Mar. 19, 2021 (JP) 2021-046560

(51) Int. Cl. B60W 30/095; B60W 30/18; B60W 50/14

(52) U.S. Cl. CPC B60W 30/0956; B60W 30/18159; B60W 50/14; B60W 2520/10; B60W 2540/20; B60W 2552/05; B60W 2554/4045; B60W 2554/4044; B60W 2554/4041

(57) ABSTRACT

A driving support device includes an own-vehicle trajectory calculation unit, an other-vehicle trajectory calculation unit, and a driving support unit. The other-vehicle trajectory calculation unit calculates an other-vehicle trajectory of another vehicle. The own-vehicle trajectory calculation unit calculates an own-vehicle trajectory of an own vehicle. The driving support unit performs driving support based on the calculated own-vehicle trajectory when the own vehicle is not to make a right/left turn, and performs driving support based on a predetermined curve curved in a direction of the right/left turn when the own vehicle is to make a right/left turn. The driving support unit performs driving support related to the other vehicle based on an intersection point between the calculated other-vehicle trajectory of the other vehicle and the own-vehicle trajectory or a curved predetermined curve of the own vehicle.

### CROSS-REFERENCE TO RELATED APPLICATION

The present application claims priority from Japanese Patent Application No. 2021-046560 filed on Mar. 19, 2021, the entire content of which is incorporated herein by reference.

### TECHNICAL FIELD

The present invention relates to a driving support device.

### BACKGROUND ART

JP-A-2012-088904 discloses a driving support device that determines whether there is a possibility of collision between an own vehicle and another vehicle, and gives a notification to a driver of the own vehicle when it is determined that there is a possibility of collision. The driving support device detects a start of a right/left turn of the own vehicle based on an acceleration of the own vehicle, and determines whether there is a possibility of collision between the own vehicle and another vehicle based on right/left turn start information.

In the related art, since a future trajectory of an own vehicle is predicted based on a behavior of the own vehicle, when the own vehicle cannot wait for a right/left turn with a sufficient angle at the time of the right/left turn, it is not possible to ensure that future trajectories of the own vehicle and another vehicle do not intersect with each other within a traffic intersection, and it is not possible to perform, with high accuracy, driving support for avoiding the collision or the like between the own vehicle and the other vehicle.

### SUMMARY

An object of the present invention is to provide a driving support device capable of improving the accuracy of driving support.

The present invention provides a driving support device including:

an other-vehicle trajectory calculation unit that calculates a trajectory of another vehicle:

an own-vehicle trajectory calculation unit that calculates a trajectory of an own vehicle; and

a driving support unit that performs driving support related to the another vehicle based on an intersection point between a trajectory of the another vehicle calculated by the other-vehicle trajectory calculation unit and a trajectory of the own vehicle calculated by the own-vehicle trajectory calculation unit,

in which the driving support unit performs the driving support based on the trajectory of the own vehicle calculated by the own-vehicle trajectory calculation unit when the own vehicle is not to make a right/left turn, and performs the driving support based on a predetermined curve curved in a direction of the right/left turn when the own vehicle is to make the right/left turn.

According to the driving support device of the present invention, it is possible to improve the accuracy of the driving support.

### BRIEF DESCRIPTION OF DRAWINGS

FIG. 1 is a diagram illustrating a configuration of a driving support device 10 that is an example of a driving support device according to the present invention.

FIG. 2 is a diagram illustrating an example of a functional configuration of a calculation unit 26.

FIG. 3 is a diagram illustrating a first specific example of derivation of an intersection point of future trajectories of an own vehicle 50 and another vehicle 60.

FIG. 4 is a diagram illustrating a second specific example of derivation of an intersection point of future trajectories of the own vehicle 50 and the other vehicle 60.

FIG. 5 is a flowchart illustrating an example of processing performed by the calculation unit 26.

FIG. 6 is a diagram illustrating another first specific example of a shape of a traffic intersection 130.

FIG. 7 is a diagram illustrating another second specific example of the shape of the traffic intersection 130.

FIG. 8 is a diagram illustrating an example of control of driving support in a traffic intersection area.

FIG. 9 is a diagram illustrating an example of control of driving support in a case where a preceding vehicle predicted to turn left in the same direction is present.

FIG. 10 is a diagram illustrating an example of control of driving support in a case where an oncoming vehicle predicted to travel in an opposite direction is present.

FIG. 11 is a diagram illustrating an example of driving support in a case where an oncoming vehicle is also present behind an oncoming vehicle.

### DESCRIPTION OF EMBODIMENTS

Hereinafter, an embodiment of a driving support device of the present invention will be described with reference to the drawings.

<Configuration of Driving Support Device 10 as Driving Support Device of the Present Invention>

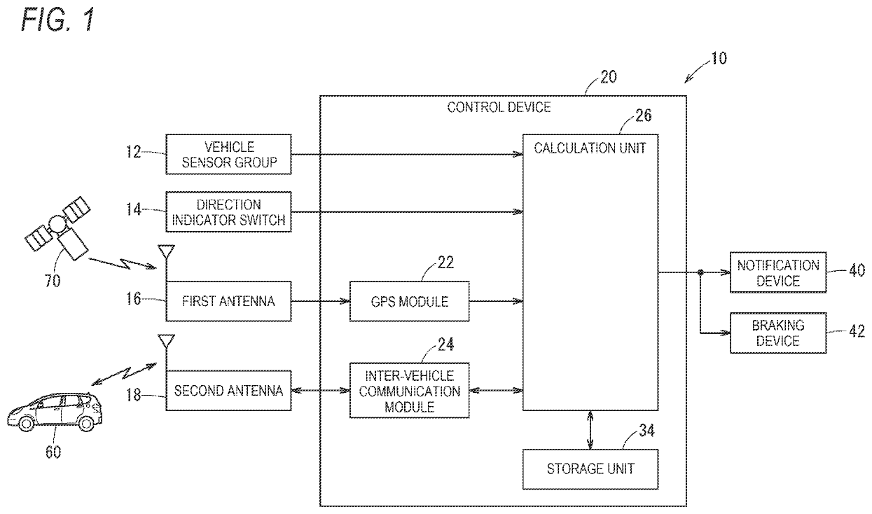

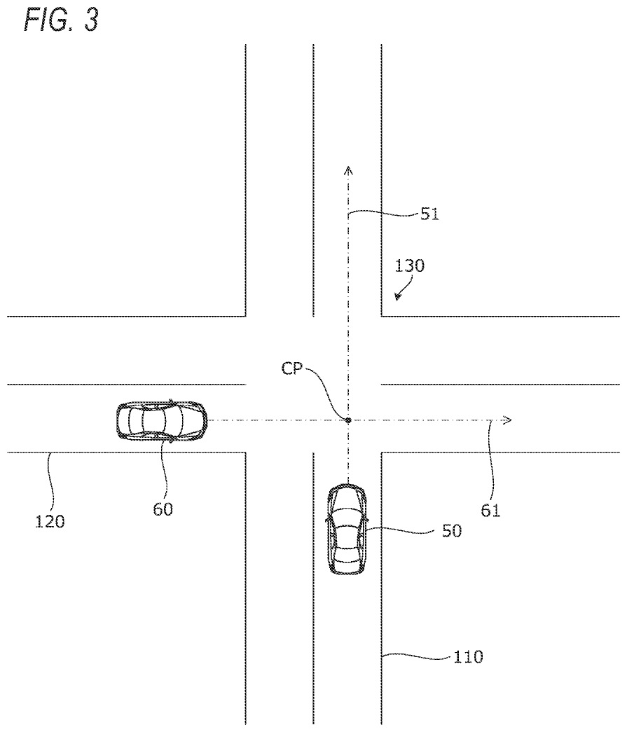

FIG. 1 is a diagram illustrating a configuration of a driving support device 10 that is an example of a driving support device according to the present invention. The driving support device 10 illustrated in FIG. 1 is provided in an own vehicle 50 (see FIG. 3 and the like), which will be described later, driven by a driver. The driving support device 10 includes a vehicle sensor group 12, a direction indicator switch 14, a first antenna 16, a second antenna 18, a control device 20, a notification device 40, and a braking device 42.

The vehicle sensor group 12 includes an altimeter in addition to sensors necessary for performing autonomous navigation, for example, a gyro sensor and an acceleration sensor. The vehicle sensor group 12 may include a digital camera that captures an image of the surroundings of the own vehicle 50, a radar device that uses radio waves in a millimeter wave band or the like, a laser imaging detection and ranging (LIDAR) that uses laser light, and the like. The vehicle sensor group 12 may include a vehicle speed sensor for acquiring vehicle speed information.

The vehicle sensor group 12 detects various types of information, and outputs the detected information to the calculation unit 26 of the control device 20. The direction indicator switch 14 outputs a signal corresponding to an operation of a direction indicator lever provided in an interior of the own vehicle 50 to the calculation unit 26. The first antenna 16 is an antenna used to perform satellite navigation. The second antenna 18 is an antenna used to perform inter-vehicle communication between the own vehicle 50 and another vehicle 60 (see FIG. 3 and the like) to be described later.

The control device 20 is an electronic control unit (ECU) in which a GPS module 22, an inter-vehicle communication module 24, the calculation unit 26, and a storage unit 34 are integrated.

The GPS module 22 is a receiver that receives, via the first antenna 16, radio waves transmitted from an artificial satellite (GPS satellite) 70. The inter-vehicle communication module 24 is a transceiver that receives, via the second antenna 18, a radio wave signal transmitted from the other vehicle 60, and transmits, via the second antenna 18, radio waves to the other vehicle 60.

The calculation unit 26 is a processor or the like including a central processing unit (CPU) or the like. The calculation unit 26 implements various functions by executing a program stored in the storage unit 34. The calculation unit 26 receives various types of information from the vehicle sensor group 12, the direction indicator switch 14, the GPS module 22, and the inter-vehicle communication module 24, and outputs a support instruction to the notification device 40 and the braking device 42.

The storage unit 34 is a memory the calculation unit 26 can access. The storage unit 34 includes, in addition to a read only memory (ROM), a storage device such as a random access memory (RAM) or a hard disk that allows reading and writing freely. The storage unit 34 stores information of a predetermined curve and the like to be described below.

The notification device 40 includes a notification ECU and an information transmission device (a display device, an acoustic device, a tactile device, or the like). The notification device 40 performs notification to the driver in accordance with an instruction output from another ECU or the control device 20.

The braking device 42 includes a brake ECU and a brake actuator. The braking device 42 generates a braking force in response to an operation of a brake pedal performed by the driver or in accordance to an instruction output from the control device 20.

<Functional Configuration of Calculation Unit 26>

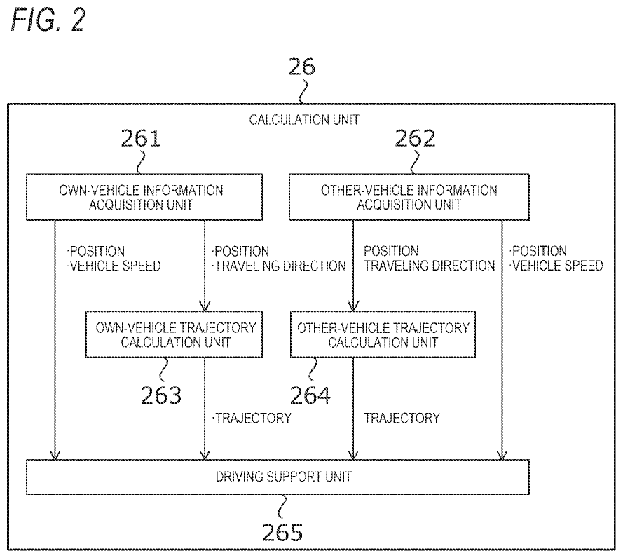

FIG. 2 is a diagram illustrating an example of a functional configuration of the calculation unit 26. As illustrated in FIG. 2, the calculation unit 26 functions as an own-vehicle information acquisition unit 261, an other-vehicle information acquisition unit 262, an own-vehicle trajectory calculation unit 263, an other-vehicle trajectory calculation unit 264, and a driving support unit 265.

The own-vehicle information acquisition unit 261 acquires traveling information of the own vehicle 50. The traveling information of the own vehicle 50 includes information such as a current position, a vehicle speed, and a traveling direction of the own vehicle 50. The traveling direction is, for example, an orientation of a body of the vehicle. For example, the own-vehicle information acquisition unit 261 acquires the traveling information based on information output from the vehicle sensor group 12 and the GPS module 22. The own-vehicle information acquisition unit 261 outputs the acquired traveling information indicating a position and a traveling direction of the own vehicle 50 to the own-vehicle trajectory calculation unit 263. In addition, the own-vehicle information acquisition unit 261 outputs the acquired traveling information indicating the position and a vehicle speed of the own vehicle 50 to the driving support unit 265.

The other-vehicle information acquisition unit 262 acquires traveling information of the other vehicle 60. The traveling information of the other vehicle 60 includes information such as a current position, a vehicle speed, and a traveling direction of the other vehicle 60. For example, the other-vehicle information acquisition unit 262 acquires the traveling information based on information output from the vehicle sensor group 12 and the inter-vehicle communication module 24. The other-vehicle information acquisition unit 262 outputs the acquired traveling information indicating a position and a traveling direction of the other vehicle 60 to the other-vehicle trajectory calculation unit 264. In addition, the other-vehicle information acquisition unit 262 outputs the acquired traveling information indicating the position and a vehicle speed of the other vehicle 60 to the driving support unit 265.

The own-vehicle trajectory calculation unit 263 calculates a future trajectory of the own vehicle 50 based on the position and the traveling direction of the own vehicle 50 indicated by the traveling information output from the own-vehicle information acquisition unit 261. The calculation of the future trajectory of the own vehicle 50 will be described later. The own-vehicle trajectory calculation unit 263 notifies the driving support unit 265 of the calculated future trajectory of the own vehicle 50.

The other-vehicle trajectory calculation unit 264 calculates a future trajectory of the other vehicle 60 based on the position and the traveling direction of the other vehicle 60 indicated by the traveling information output from the other-vehicle information acquisition unit 262. The calculation of the future trajectory of the other vehicle 60 will be described later. The other-vehicle trajectory calculation unit 264 notifies the driving support unit 265 of the calculated future trajectory of the other vehicle 60.

When the own vehicle 50 is not to turn left at a traffic intersection, the driving support unit 265 derives an intersection point between the future trajectory of the own vehicle 50 notified from the own-vehicle trajectory calculation unit 263 and the future trajectory of the other vehicle 60 notified from the other-vehicle trajectory calculation unit 264. When the own vehicle 50 is to turn left at the traffic intersection, the driving support unit 265 derives an intersection point between a predetermined curve, which extends from a current position of the own vehicle 50 and is curved in a left direction, and the future trajectory of the other vehicle 60 notified from the other-vehicle trajectory calculation unit 264.

The driving support unit 265 detects a possibility of collision or abnormal approach in the future between the own vehicle 50 and the other vehicle 60 based on the derived intersection point, the position and the vehicle speed of the own vehicle 50 indicated by the traveling information output from the own-vehicle information acquisition unit 261, and the position and the vehicle speed of the other vehicle 60 indicated by the traveling information output from the other-vehicle information acquisition unit 262, and performs driving support based on a detection result. The driving support is control for avoiding collision or abnormal approach between the own vehicle 50 and the other vehicle 60.

For example, the driving support is notification control of controlling the notification device 40 to notify an occupant (in particular, the driver) of the own vehicle 50 of presence or the like of the other vehicle 60. However, the driving support is not limited to such notification control. For example, the driving support may be control of controlling the other vehicle 60 to notify an occupant (particularly, a driver) of the other vehicle 60 of presence or the like of the own vehicle 50 by communicating with the other vehicle 60. Alternatively, the driving support may be brake control of the own vehicle 50 by controlling the braking device 42, steering control of the own vehicle 50, or the like.

<First Specific Example of Derivation of Intersection Point of Future Trajectories of Own Vehicle 50 and Other Vehicle 60>

FIG. 3 is a diagram illustrating a first specific example of derivation of an intersection point of future trajectories of the own vehicle 50 and the other vehicle 60. Here, a case of driving on the right-hand side in which each vehicle travels in a lane on the right-hand side thereof to implement two-way traffic will be described. In the driving on the right-hand side, when the own vehicle 50 turns left at a traffic intersection, there is a high risk that the own vehicle 50 collides with or abnormally approaches the other vehicle 60 traveling straight on in an opposite lane.

A traffic intersection 130 illustrated in FIG. 3 is a traffic intersection between a first traveling road 110 and a second traveling road 120. The own vehicle 50 on which the driving support device 10 is mounted is traveling on the first traveling road 110 and is scheduled to travel straight through the traffic intersection 130. The other vehicle 60 different from the own vehicle 50 is traveling on the second traveling road 120 and is scheduled to travel straight through the traffic intersection 130.

An own-vehicle trajectory 51 is a trajectory of the own vehicle 50 calculated by the own-vehicle trajectory calculation unit 263 of the own vehicle 50. The own-vehicle trajectory calculation unit 263 calculates a straight line extending from a current position of the own vehicle 50 in a current traveling direction (front-rear direction) of the own vehicle 50 as the own-vehicle trajectory 51. In this way, the own-vehicle trajectory calculation unit 263 calculates, for example, the own-vehicle trajectory 51 using a straight line in the traveling direction of the own vehicle 50.

An other-vehicle trajectory 61 is a trajectory of the other vehicle 60 calculated by the other-vehicle trajectory calculation unit 264 of the own vehicle 50. The other-vehicle trajectory calculation unit 264 calculates a straight line extending from a current position of the other vehicle 60 in a current traveling direction of the other vehicle 60 as the other-vehicle trajectory 61. In this way, the other-vehicle trajectory calculation unit 264 calculates, for example, the other-vehicle trajectory 61 using a straight line in the traveling direction of the other vehicle 60.

When the own vehicle 50 is not to turn left at the traffic intersection 130, the driving support unit 265 derives an intersection point CP between the own-vehicle trajectory 51 and the other-vehicle trajectory 61. The driving support unit 265 performs driving support related to the other vehicle 60 based on the derived intersection point CP. For example, the driving support unit 265 calculates a time-point, at which the own vehicle 50 passes through the intersection point CP, based on a current position and a vehicle speed of the own vehicle 50. In addition, the driving support unit 265 calculates a time-point, at which the other vehicle 60 passes through the intersection point CP, based on a current position and a vehicle speed of the other vehicle 60.

If a difference between the calculated time-points is equal to or less than a predetermined period of time, the driving support unit 265 performs the driving support for avoiding a collision or the like between the own vehicle 50 and the other vehicle 60. For example, the driving support unit 265 performs notification control of notifying the occupant of the own vehicle 50 of presence of the other vehicle 60. In addition, the driving support unit 265 does not perform the driving support if the difference between the calculated time-points is greater than the predetermined period of time.

The predetermined period of time may be arbitrarily set, and may be set to, for example, a period of time (for example, 3 seconds) in which the own vehicle 50 traveling at 30 km/h can stop without sudden braking.

<Second Specific Example of Derivation of Intersection Point of Trajectories of Own Vehicle 50 and Other Vehicle 60>

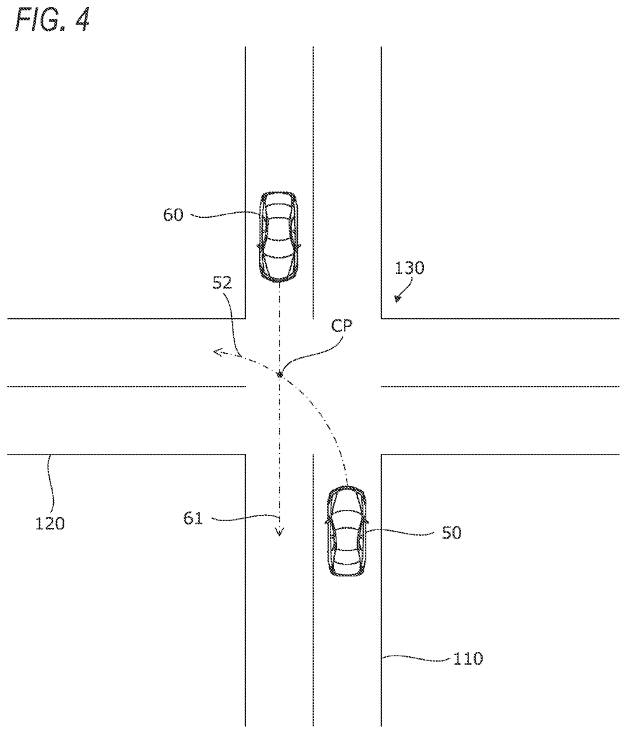

FIG. 4 is a diagram illustrating a second specific example of derivation of an intersection point of future trajectories of the own vehicle 50 and the other vehicle 60. In the second specific example illustrated in FIG. 4, the own vehicle 50 is traveling on the first traveling road 110 and is scheduled to turn left at the traffic intersection 130. The other vehicle 60 is traveling on the first traveling road 110 in a direction opposite to that of the own vehicle 50, and is scheduled to travel straight through the traffic intersection 130.

The driving support unit 265 determines that the own vehicle 50 is to turn left at the traffic intersection 130 based on, for example, information output from the direction indicator switch 14, that is, operation information of a winker of the own vehicle 50. For example, the driving support unit 265 determines that the own vehicle 50 is to turn left at the traffic intersection 130 in a case where a leftward indicator (winker) is operating when the own vehicle 50 is located in front of the traffic intersection 130. However, the determination as to whether the own vehicle 50 is to turn left at the traffic intersection 130 is not limited to being made based on the operation information of the winker, and may be made based on navigation information of the own vehicle 50, position information and a vehicle speed, a yaw rate, or the like of the own vehicle 50.

Further, since the driving support unit 265 determines that the own vehicle 50 is to turn left, the driving support unit 265 derives an intersection point CP between a predetermined curve 52, which extends from the current position of the own vehicle 50 and is curved in the left direction, and the other-vehicle trajectory 61. For example, in a memory (for example, the storage unit 34) the calculation unit 26 can access, a curve curved to the left at a predetermined curvature is stored in advance in association with a left turn. The driving support unit 265 derives the curve 52 by reading the curve and extending the curve from the current position of the own vehicle 50. In this way, when the own vehicle 50 is to turn left, the driving support unit 265 derives the intersection point CP by using the curve 52 curved in the left direction instead of using the own-vehicle trajectory 51.

Similarly to the example of FIG. 3, the other-vehicle trajectory calculation unit 264 calculates a straight line, which extends from the current position of the other vehicle 60 in the current traveling direction of the other vehicle 60, as the other-vehicle trajectory 61.

The driving support unit 265 performs driving support related to the other vehicle 60 based on the intersection point CP of the own-vehicle trajectory 51 and the other-vehicle trajectory 61. A specific example of the driving support is the similar to the example in FIG. 3.

<Processing by Calculation Unit 26>

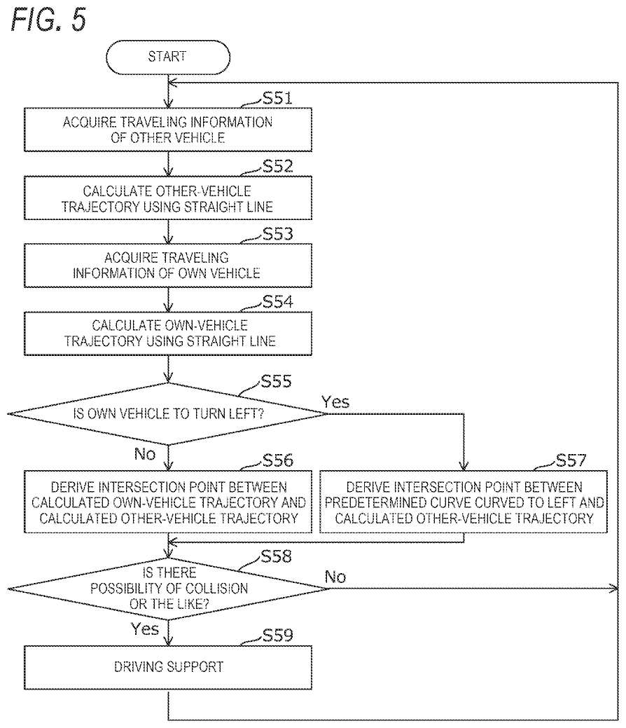

FIG. 5 is a flowchart illustrating an example of processing performed by the calculation unit 26. The calculation unit 26 executes, for example, the processing illustrated in FIG. 5.

First, the calculation unit 26 acquires traveling information of the other vehicle 60 (step S51). Step S51 is executed by the other-vehicle information acquisition unit 262. Next, the calculation unit 26 calculates the other-vehicle trajectory 61 using a straight line based on the traveling information acquired in step S51 (step S52). Step S52 is executed by the other-vehicle trajectory calculation unit 264.

Next, the calculation unit 26 acquires traveling information of the own vehicle 50 (step S53). Step S53 is executed by the own-vehicle information acquisition unit 261. Next, the calculation unit 26 calculates the own-vehicle trajectory 51 using a straight line based on the traveling information acquired in step S53 (step S54). Step S54 is executed by the own-vehicle trajectory calculation unit 263.

Next, the calculation unit 26 determines whether the own vehicle 50 is to turn left (step S55). Step S55 is executed by, for example, the own-vehicle trajectory calculation unit 263.

When it is determined in step S55 that the own vehicle 50 is not to turn left (step S55: No), the calculation unit 26 derives the intersection point CP between the own-vehicle trajectory 51 calculated in step S54 and the other-vehicle trajectory 61 calculated in step S52 (step S56). Step S56 is executed by the driving support unit 265.

When it is determined in step S55 that the own vehicle 50 is to turn left (step S55: Yes), the calculation unit 26 derives the intersection point CP between the predetermined curve 52 curved to the left and the other-vehicle trajectory 61 calculated in step S52 (step S57). Step S57 is executed by the driving support unit 265.

Next, the calculation unit 26 determines whether there is a possibility of collision or abnormal approach (collision or the like) between the own vehicle 50 and the other vehicle 60 based on the intersection point CP derived in step S56 or step S57 (step S58). Step S58 is executed by the driving support unit 265. When there is no possibility of collision or the like (step S58: No), the calculation unit 26 returns to step S51.

When there is a possibility of a collision or the like in step S58 (step S58: Yes), the calculation unit 26 performs driving support for avoiding the collision or the like (step S59), and returns to step S51. Step S59 is executed by the driving support unit 265.

The steps shown in FIG. 5 can be changed as appropriate. For example, the order of steps S51 and S52 and steps S53 and S54 may be changed. When the own vehicle 50 is to turn left, step S54 may not be executed. When there are a plurality of other vehicles 60, the calculation unit 26 may execute the processing illustrated in FIG. 5 for each of the plurality of other vehicles 60. At this time, the calculation unit 26 may execute steps S53 to S55 in common for each of the plurality of other vehicles 60.

As illustrated in FIGS. 3 to 5, the driving support device 10 derives an intersection point CP between the own-vehicle trajectory 51 and the other-vehicle trajectory 61 calculated using straight lines when the own vehicle 50 is not to turn left, and derives an intersection point CP between the predetermined curve 52 curved to the left and the other-vehicle trajectory 61 when the own vehicle 50 is to turn left. Accordingly, the intersection point CP can be derived with higher accuracy than in a case where the intersection point CP is always derived using a trajectory calculated based on a behavior of the own vehicle 50, and an increase in the amount of calculation for deriving the intersection point CP can be suppressed. Therefore, it is possible to improve the accuracy of the driving support that is based on the intersection point CP.

<Other Specific Examples of Shape of Traffic Intersection 130>

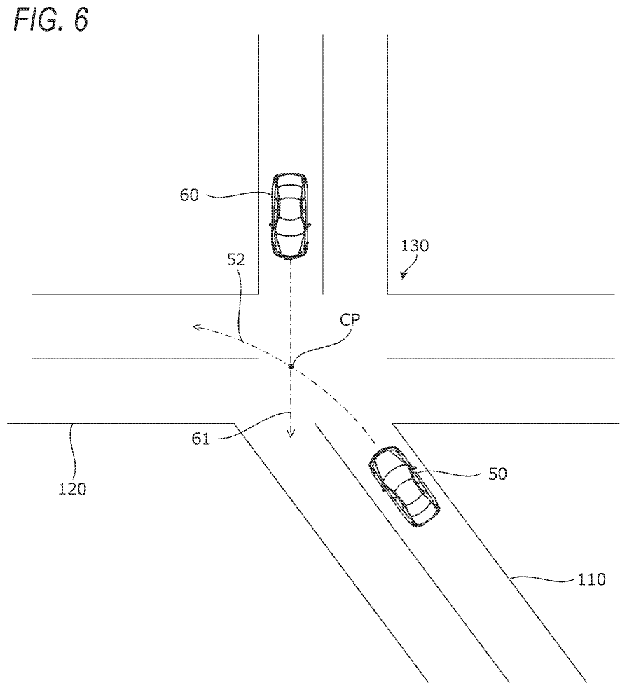

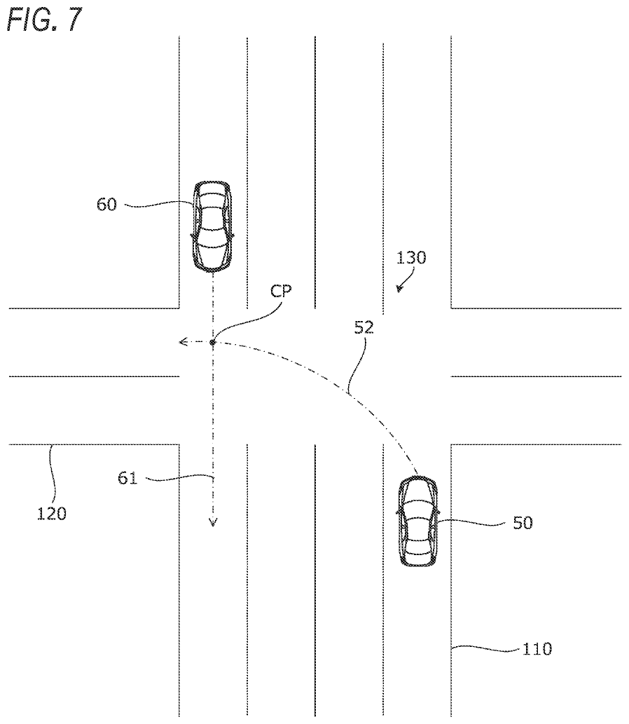

FIG. 6 is a diagram illustrating another first specific example of a shape of the traffic intersection 130. FIG. 7 is a diagram illustrating another second specific example of the shape of the traffic intersection 130.

FIG. 6 illustrates the traffic intersection 130 in which an intersection angle between the first traveling road 110 and the second traveling road 120 is partially different from that in the example of FIG. 4. FIG. 7 illustrates the traffic intersection 130 in which the number of lanes of the first traveling road 110 is different from that in the example of FIG. 4.

For example, in a memory (for example, the storage unit 34) the calculation unit 26 can access, a curve curved to the left may be stored in association with each shape of the traffic intersection (for example, each shape of the traffic intersection 130 in FIGS. 4, 6, and 7). These curves have different shapes (lengths and curvatures) in accordance with the shapes of the corresponding traffic intersections. The calculation unit 26 determines the shape of the traffic intersection 130, reads a curve corresponding to the determined shape from the memory, and derives the intersection point CP.

The determination of the shape of the traffic intersection 130 may be performed, for example, based on map data including information indicating the shape of the traffic intersection 130, or may be performed based on an image-capturing result by a digital camera provided in the vehicle sensor group 12.

As described above, the calculation unit 26 may derive the intersection point CP by using a curve having a shape corresponding to the shape of the traffic intersection 130 at which the own vehicle 50 makes a left turn, among a plurality of curves having different shapes. Accordingly, it is possible to derive the intersection point CP more accurately while suppressing an increase in the amount of calculation for deriving the intersection point CP. Therefore, it is possible to further improve the accuracy of the driving support that is based on the intersection point CP.

<Driving Support in Traffic Intersection Area>

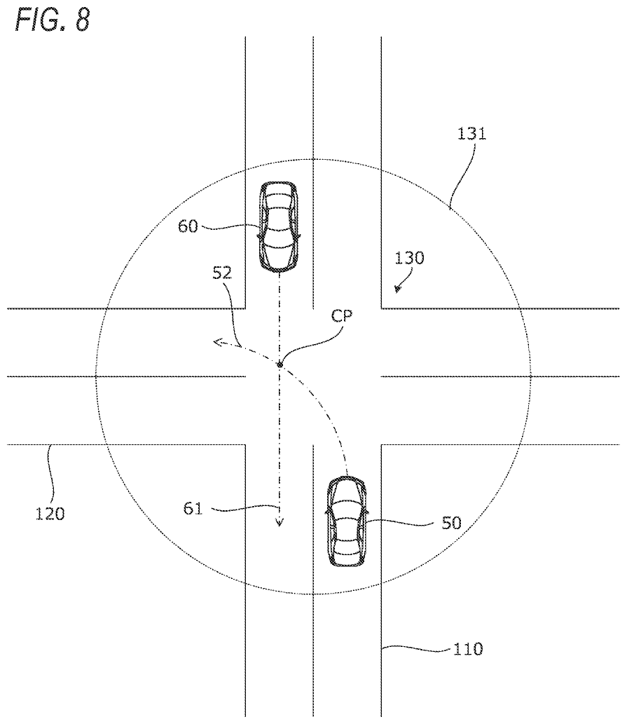

FIG. 8 is a diagram illustrating an example of control of driving support in a traffic intersection area. A traffic intersection area 131 illustrated in FIG. 8 is an area including the traffic intersection 130 and the vicinity of the traffic intersection 130. For example, the traffic intersection area 131 is a circular area centered on the traffic intersection 130 and including a part of the traffic intersection 130. The driving support unit 265 may perform the driving support when the own vehicle 50 is present in the traffic intersection area 131, and may not perform the driving support when the own vehicle 50 is not present in the traffic intersection area 131.

The determination as to whether the own vehicle 50 is present in the traffic intersection area 131 may be performed, for example, based on map data including information indicating the shape of the traffic intersection 130, or may be performed based on an image-capturing result by a digital camera provided in the vehicle sensor group 12. The traffic intersection area 131 may be an area within a predetermined range centered on the intersection point CP.

In this way, the driving support unit 265 may perform the driving support when the own vehicle 50 is present in the traffic intersection 130 or in the vicinity of the traffic intersection 130. The driving support for avoiding a collision or the like between the own vehicle 50 and the other vehicle 60 is not performed when the own vehicle 50 is not present in the traffic intersection 130 or in the vicinity of the traffic intersection 130, so that it is possible to avoid a situation in which the occupant or the like of the own vehicle 50 feels annoyed when the notification control or the like is executed in a state in which the possibility of a collision or the like between the own vehicle 50 and the other vehicle 60 is low.

<Control of Driving Support in Case Where Preceding Vehicle Predicted to Turn Left in Same Direction Is Present>

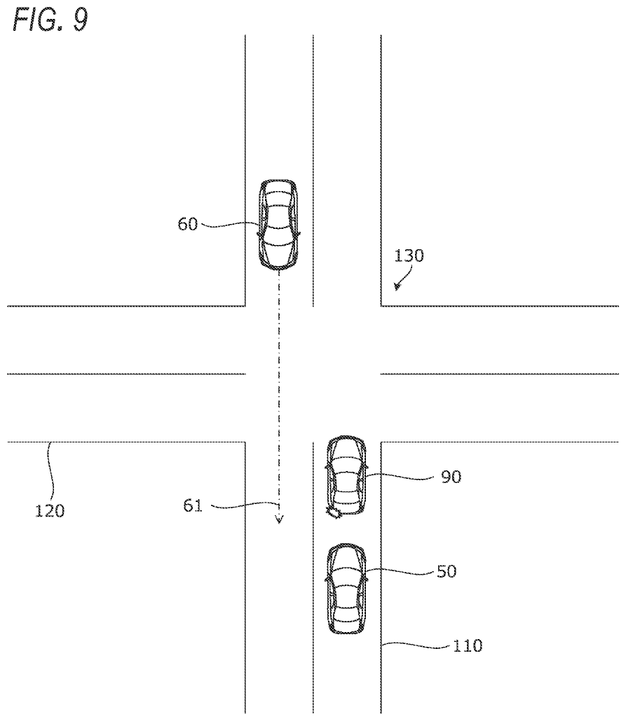

FIG. 9 is a diagram illustrating an example of control of driving support in a case where a preceding vehicle predicted to turn left in the same direction is present. In the example of FIG. 9, the own vehicle 50 is scheduled to turn left at the traffic intersection 130, and a preceding vehicle 90 is present in front of the own vehicle 50.

The driving support unit 265 of the own vehicle 50 predicts whether the preceding vehicle 90 is to turn left at the traffic intersection 130. The prediction of whether the preceding vehicle 90 is to turn left at the traffic intersection 130 can be performed, for example, by inter-vehicle communication between the own vehicle 50 and the preceding vehicle 90 or by capturing an image of the preceding vehicle 90 by a digital camera provided in the vehicle sensor group 12. The prediction of whether the preceding vehicle 90 is to turn left at the traffic intersection 130, which is to be performed by capturing an image of the preceding vehicle 90, can be performed by determining, based on an image-capturing result, whether a winker on the left side of the preceding vehicle 90 is operating or whether the preceding vehicle 90 is at an angle in the left direction at the traffic intersection 130.

When it is predicted that the preceding vehicle 90 is not to turn left at the traffic intersection 130, the driving support unit 265 performs driving support related to the other vehicle 60 as described above. When it is predicted that the preceding vehicle 90 is to turn left at the traffic intersection 130, the driving support unit 265 waits until the preceding vehicle 90 starts turning left, and then performs the driving support related to the other vehicle 60 as described above. The determination as to whether the preceding vehicle 90 starts to turn left can be performed, for example, by inter-vehicle communication between the own vehicle 50 and the preceding vehicle 90, or by capturing an image of the preceding vehicle 90 by a digital camera provided in the vehicle sensor group 12.

As described above, in a case where the preceding vehicle 90 predicted to turn left in the same direction as the own vehicle 50 is present in front of the own vehicle 50 when the own vehicle 50 is to make a left turn, the driving support unit 265 performs driving support after the preceding vehicle 90 starts to turn left. Accordingly, the driving support for avoiding a collision or the like between the own vehicle 50 and the other vehicle 60 is not performed in a state where the own vehicle 50 cannot turn left, so that it is possible to avoid the occupant or the like of the own vehicle 50 from feeling annoyed.

Although the control of not performing the driving support in the case where the preceding vehicle 90 predicted to turn left in the same direction as the own vehicle 50 is present is described, the control of not performing the driving support in the case where the preceding vehicle 90 is present may be performed regardless of whether the preceding vehicle 90 is to turn left in the same direction as the own vehicle 50.

<Control of Driving Support in Case Where Oncoming Vehicle Predicted to Travel in Opposite Direction Is Present>

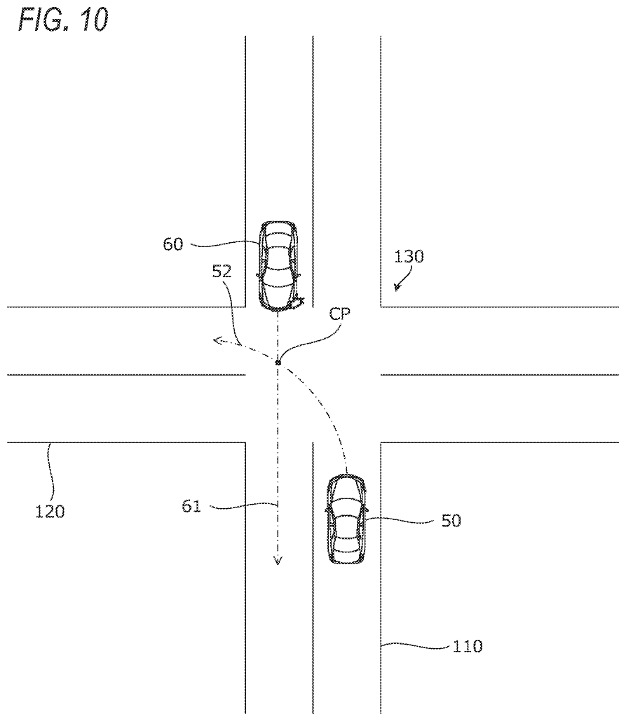

FIG. 10 is a diagram illustrating an example of control of driving support in a case where an oncoming vehicle predicted to travel in an opposite direction is present. In the example of FIG. 10, the own vehicle 50 is scheduled to turn left at the traffic intersection 130, the other vehicle 60 that is an oncoming vehicle is present in front of the own vehicle 50, and the other vehicle 60 is scheduled to turn left at the traffic intersection 130, that is, to travel in a direction opposite to that of the own vehicle 50.

In this case, the driving support unit 265 may not perform the driving support related to the other vehicle 60 that is based on an intersection point of the own-vehicle trajectory 51 and the other-vehicle trajectory 61. The prediction of whether the other vehicle 60 is to turn left at the traffic intersection 130 can be performed by, for example, inter-vehicle communication between the own vehicle 50 and the other vehicle 60 or by capturing an image of the other vehicle 60 by a digital camera provided in the vehicle sensor group 12. The prediction of whether the other vehicle 60 is to turn left at the traffic intersection 130, which is to be performed by capturing an image of the other vehicle 60, can be performed by determining, based on an image-capturing result, whether a winker on the right side of the other vehicle 60 as viewed from the own vehicle 50 is operating or whether the other vehicle 60 is at an angle in the right direction at the traffic intersection 130 as viewed from the own vehicle 50.

As described, in a case where the other vehicle 60, which is an oncoming vehicle predicted to travel in a direction opposite to a direction in which the own vehicle 50 travels in the left turn, is present in front of the own vehicle 50 when the own vehicle 50 is to make a left turn, the driving support unit 265 does not perform the driving support related to the other vehicle 60. Accordingly, it is possible to avoid calculating the other-vehicle trajectory 61 of the other vehicle 60 using a straight line, and it is possible to avoid a situation in which the occupant or the like of the own vehicle 50 feels annoyed when the notification control or the like is executed in a state in which the possibility of a collision or the like between the own vehicle 50 and the other vehicle 60 is low.

<Driving Support in Case Where Oncoming Vehicle Is also Present on Rear Side in Traveling Direction of Oncoming Vehicle>

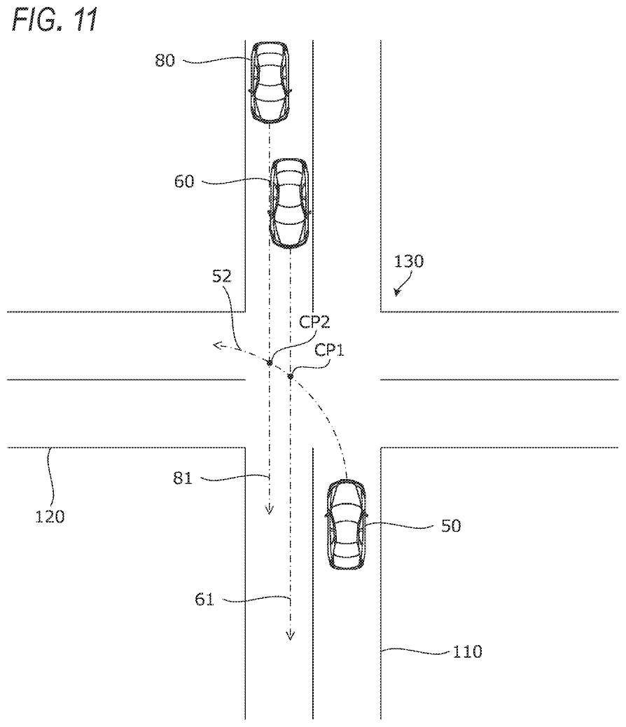

FIG. 11 is a diagram illustrating an example of driving support in a case where an oncoming vehicle is also present behind an oncoming vehicle. In the example of FIG. 11, similarly to the situation in FIG. 4, another vehicle 80 is present behind the other vehicle 60 in the traveling direction of the other vehicle 60. Similarly to the other vehicle 60, the other vehicle 80 is traveling on the first traveling road 110 in a direction opposite to that of the own vehicle 50, and is scheduled to travel straight through the traffic intersection 130.

The other-vehicle information acquisition unit 262 acquires traveling information of the other vehicle 80 in addition to the traveling information of the other vehicle 60. The other-vehicle trajectory calculation unit 264 also calculates an other-vehicle trajectory 81 of the other vehicle 80 in addition to the other-vehicle trajectory 61 of the other vehicle 60. An intersection point CP1 is an intersection point between the curve 52 and the other-vehicle trajectory 61, and an intersection point CP2 is an intersection point between the curve 52 and the other-vehicle trajectory 81.

Since there is a possibility of a collision or the like between the own vehicle 50 and the other vehicle 60 at the intersection point CP1, the driving support unit 265 performs notification control related to the other vehicle 60 to the occupant of the own vehicle 50 as driving support. For example, the driving support unit 265 performs the notification control of controlling the notification device 40 to perform notification using a speech of “Please pay attention to the oncoming vehicle traveling straight while turning left” or the like.

In addition, since there is a possibility of a collision or the like between the own vehicle 50 and the other vehicle 80 at the intersection point CP2, the driving support unit 265 further performs notification control related to the other vehicle 80 to the occupant of the own vehicle 50 as driving support. At this time, the driving support unit 265 performs the notification control related to the other vehicle 80 in a mode different from the notification control related to the other vehicle 60. For example, the driving support unit 265 performs the notification control of controlling the notification device 40 to perform notification using a speech of “An oncoming vehicle is behind the oncoming vehicle. Please pay attention while turning left” or the like.

As described, when the other vehicle 60 (first oncoming vehicle) that is an oncoming vehicle is present in front of the own vehicle 50 and the other vehicle 80 that is an oncoming vehicle is also present behind the other vehicle 60, the driving support unit 265 makes a notification regarding the other vehicle 60 different from a notification regarding the other vehicle 80. Accordingly, even in a situation where the other vehicle 80 is hidden by the other vehicle 60 and is difficult to see as viewed from the own vehicle 50, the occupant of the own vehicle 50 can be made aware of the presence of the other vehicle 80 present behind the other vehicle 60.

Therefore, it is possible to prevent a situation in which the occupant of the own vehicle 50 misunderstands the notification regarding the other vehicle 80 as the notification regarding the other vehicle 60 in front, and pays attention to the other vehicle 60 but does not pay attention to the other vehicle 80, leading to a collision or the like between the own vehicle 50 and the other vehicle 80.

Here, although a case where message content of the notification by the speech regarding the other vehicle 60 and message content of the notification by the speech regarding the other vehicle 80 are made different from each other is described, the mode of making the notifications different is not limited thereto. For example, the driving support unit 265 may perform notification control of performing notification by screen display, and may cause a message or an icon to be displayed on a screen to be different between the notification regarding the other vehicle 60 and the notification regarding the other vehicle 80. In addition, the driving support unit 265 may perform notification control of performing notification by in-vehicle illumination of the own vehicle 50, and may cause a color of the in-vehicle illumination to be different between the notification regarding the other vehicle 60 and the notification regarding the other vehicle 80.

Although the embodiment of the present invention has been described above, the present invention is not limited to the above-described embodiment, and modifications, improvements, and the like can be made as appropriate.

For example, although the case where the own vehicle 50 makes a left turn in the driving on the right-hand side is described in the above-described embodiment, the same control may be performed also in a case where the own vehicle 50 makes a right turn in the driving on the right-hand side. For example, when the own vehicle 50 is to turn right, the driving support unit 265 may derive the intersection point CP between a curve curved to the right and the other-vehicle trajectory 61. Accordingly, it is possible to perform driving support with high accuracy even when the own vehicle 50 turns right.

Further, although driving on the right-hand side is described as an example in the above-described embodiment, the above-described embodiment can also be applied to driving on the left-hand side. In this case, the driving support device 10 derives the intersection point CP between the own-vehicle trajectory 51 and the other-vehicle trajectory 61 calculated using straight lines when the own vehicle 50 is not to turn right, and derives the intersection point CP between a predetermined curve curved to the right and the other-vehicle trajectory 61 when the own vehicle 50 is to turn right. Further, the same control may be performed when the own vehicle 50 is to turn left in the driving on the left-hand side.

That is, the driving support device 10 derives the intersection CP between the own-vehicle trajectory 51 and the other-vehicle trajectory 61 calculated using straight lines when the own vehicle 50 is not to turn right or left (turn right or turn left), and derives the intersection point CP between a predetermined curve curved in the direction of the right turn or left turn and the other-vehicle trajectory 61 when the own vehicle 50 is to turn right or left.

In addition, although a configuration in which the own-vehicle trajectory calculation unit 263 calculates the own-vehicle trajectory 51 using a straight line is described, the present invention is not limited to such a configuration, and the own-vehicle trajectory calculation unit 263 may calculate the own-vehicle trajectory 51 using a curve based on a yaw rate or the like of the own vehicle 50. Similarly, although a configuration in which the other-vehicle trajectory calculation unit 264 calculates the other-vehicle trajectories 61 and 81 using straight lines is described, the present invention is not limited thereto, and the other-vehicle trajectory calculation unit 264 may calculate the other-vehicle trajectories 61 and 81 using curves based on a yaw rate or the like of the other-vehicle 60.

In addition, although a configuration in which the other-vehicle trajectory calculation unit 264 calculates the other-vehicle trajectories 61 and 81 based on the traveling information of the other vehicles 60 and 80 is described, in a case where the traveling information of the other vehicles 60 and 80 acquired by the other-vehicle information acquisition unit 262 includes trajectory information indicating future trajectories of the other vehicles 60 and 80, the driving support unit 265 may calculate the other-vehicle trajectories 61 and 81 based on the trajectory information.

At least the following matters are described in the present specification. Although corresponding constituent elements or the like in the above-described embodiment are illustrated in parentheses, the present invention is not limited thereto.

(1) A driving support device (driving support device 10) including:

an other-vehicle trajectory calculation unit (other-vehicle trajectory calculation unit 264) that calculates a trajectory (other-vehicle trajectories 61, 81) of another vehicle (other-vehicles 60, 80);

an own-vehicle trajectory calculation unit (own-vehicle trajectory calculation unit 263) that calculates a trajectory (own-vehicle trajectory 51) of an own vehicle (own vehicle 50); and

a driving support unit (driving support unit 265) that performs driving support related to the another vehicle based on an intersection point (intersection points CP, CP1, CP2) between a trajectory of the another vehicle calculated by the other-vehicle trajectory calculation unit and a trajectory of the own vehicle calculated by the own-vehicle trajectory calculation unit,

in which the driving support unit performs the driving support based on the trajectory of the own vehicle calculated by the own-vehicle trajectory calculation unit when the own vehicle is not to make a right/left turn, and performs the driving support based on a predetermined curve (curve 52) curved in a direction of the right/left turn when the own vehicle is to make the right/left turn.

According to (1), when the own vehicle is not to make a right/left turn, the trajectory of the own vehicle can be predicted using a straight line, and when the own vehicle is to make a right/left turn, the trajectory of the own vehicle can be predicted using a predetermined curve curved in the direction of the right/left turn. Accordingly, it is possible to accurately predict the trajectory of the own vehicle as compared with a case where the trajectory is derived using a trajectory calculated based on a behavior of the own vehicle, and it is possible to suppress an increase in the amount of calculation for predicting the trajectory of the own vehicle. Therefore, it is possible to improve the accuracy of the driving support that is based on the intersection point between the trajectory of the own vehicle and the trajectory of the another vehicle.

(2) The driving support device according to (1),

in which the driving support unit determines whether the own vehicle is to make the right/left turn based on operation information of a winker of the own vehicle, navigation information of the own vehicle, or position information and a vehicle speed of the own vehicle.

According to (2), it is possible to easily determine whether the own vehicle is to make a right/left turn.

(3) The driving support device according to (1) or (2),

in which the driving support unit performs the driving support when the own vehicle is present in a traffic intersection or in a vicinity of the traffic intersection (traffic intersection area 131).

According to (3), the driving support for avoiding a collision or the like between the own vehicle and the another vehicle is not performed when the own vehicle is not present in the traffic intersection or in the vicinity of the traffic intersection, so that it is possible to avoid a situation in which an occupant or the like of the own vehicle feels annoyed when notification control or the like is executed in a state in which the possibility of a collision or the like between the own vehicle and the another vehicle is low.

(4) The driving support device according to (3),

in which in a case where a preceding vehicle (preceding vehicle 90) predicted to make a right/left turn in a same direction as the own vehicle is present when the own vehicle is to perform the right/left turn, the driving support unit performs the driving support after the preceding vehicle starts the right/left turn.

According to (4), the driving support for avoiding a collision or the like between the own vehicle and the another vehicle is not performed in a state where the own vehicle cannot turn right/left, so that it is possible to avoid the occupant or the like of the own vehicle 50 from feeling annoyed.

(5) The driving support device according to any one of (1) to (4),

in which in a case where an oncoming vehicle predicted to travel in a direction opposite to a direction in which the own vehicle travels in the right/left turn is present when the own vehicle is to perform the right/left turn, the driving support unit does not perform the driving support related to the oncoming vehicle.

According to (5), it is possible to avoid predicting the trajectory of the another vehicle using a straight line, and it is possible to avoid a situation in which the occupant or the like of the own vehicle feels annoyed when the driving support is executed in a state in which the possibility of a collision or the like between the own vehicle and the another vehicle is low.

(6) The driving support device according to any one of (1) to (5),

in which the driving support includes a notification regarding the another vehicle to an occupant of the own vehicle, and

in which when a first oncoming vehicle is present in front of the own vehicle and a second oncoming vehicle is present behind the first oncoming vehicle, the driving support unit causes the notification regarding the first oncoming vehicle and the notification regarding the second oncoming vehicle to be different from each other.

According to (6), even in a situation in which the second oncoming vehicle is hidden by the first oncoming vehicle and is difficult to see when viewed from the own vehicle, the occupant of the own vehicle can be made aware of the presence of the second oncoming vehicle present behind the first oncoming vehicle. Therefore, it is possible to prevent a situation in which the occupant of the own vehicle misunderstands the notification regarding the second oncoming vehicle as the notification regarding the first oncoming vehicle in front, and pays attention to the first oncoming vehicle but does not pay attention to the second oncoming vehicle, leading to a collision or the like between the own vehicle and the second oncoming vehicle.

(7) The driving support device according to any one of (1) to (6),

in which the driving support unit performs the driving support based on a curve having a shape corresponding to a shape of a traffic intersection at which the own vehicle makes the right/left turn, among a plurality of the predetermined curves having different shapes.

According to (7), it is possible to more accurately predict the trajectory of the own vehicle while suppressing an increase in the amount of calculation for predicting the trajectory of the own vehicle. Therefore, it is possible to further improve the accuracy of the driving support that is based on the intersection point between the trajectory of the own vehicle and the trajectory of the another vehicle.

What is claimed is:

1. A driving support device comprising:
an other-vehicle trajectory calculation unit that calculates a trajectory of another vehicle;
an own-vehicle trajectory calculation unit that calculates a trajectory of an own vehicle; and
a driving support unit that performs driving support related to the another vehicle based on an intersection point between a trajectory of the another vehicle calculated by the other-vehicle trajectory calculation unit and a trajectory of the own vehicle calculated by the own-vehicle trajectory calculation unit,
wherein the driving support unit performs the driving support based on the trajectory of the own vehicle calculated by the own-vehicle trajectory calculation unit when the own vehicle is not to make a right/left turn, and performs the driving support based on a predetermined curve curved in a direction of the right/left turn when the own vehicle is to make the right/left turn.

2. The driving support device according to claim 1,
wherein the driving support unit determines whether the own vehicle is to make the right/left turn based on operation information of a winker of the own vehicle, navigation information of the own vehicle, or position information and a vehicle speed of the own vehicle.

3. The driving support device according to claim 1,
wherein the driving support unit performs the driving support when the own vehicle is present in a traffic intersection or in a vicinity of the traffic intersection.

4. The driving support device according to claim 3,
wherein in a case where a preceding vehicle predicted to make a right/left turn in a same direction as the own vehicle is present when the own vehicle is to perform the right/left turn, the driving support unit performs the driving support after the preceding vehicle starts the right/left turn.

5. The driving support device according to claim 1,
wherein in a case where an oncoming vehicle predicted to travel in a direction opposite to a direction in which the own vehicle travels in the right/left turn is present when the own vehicle is to perform the right/left turn, the driving support unit does not perform the driving support related to the oncoming vehicle.

6. The driving support device according to claim 1,
wherein the driving support includes a notification regarding the another vehicle to an occupant of the own vehicle, and
wherein when a first oncoming vehicle is present in front of the own vehicle and a second oncoming vehicle is present behind the first oncoming vehicle, the driving support unit causes the notification regarding the first oncoming vehicle and the notification regarding the second oncoming vehicle to be different from each other.

7. The driving support device according to claim 1,
wherein the driving support unit performs the driving support based on a curve having a shape corresponding to a shape of a traffic intersection at which the own vehicle makes the right/left turn, among a plurality of the predetermined curves having different shapes.
